(19) United States
(12) Patent Application Publication
(10) Pub. No.: US 2014/0047368 A1
(43) Pub. Date: Feb. 13, 2014

(54) APPLICATION DEVELOPMENT TOOL

(71) Applicants: Edward YANG, San Jose, CA (US); Hanju Kim, Palo Alto, CA (US); Robyn J. Chan, San Francisco, CA (US)

(72) Inventors: Edward YANG, San Jose, CA (US); Hanju Kim, Palo Alto, CA (US); Robyn J. Chan, San Francisco, CA (US)

(73) Assignee: Magnet Systems Inc., Palo Alto, CA (US)

(21) Appl. No.: 13/584,734

(22) Filed: Aug. 13, 2012

(51) Int. Cl. G06F 3/0484; G06F 3/0486

(52) U.S. Cl. CPC G06F 3/0484; G06F 3/0486
USPC 715/769; 715/771

(57) ABSTRACT

Systems and processes for displaying a graphical user interface control are described. API indicators may be displayed in response to a request for an API listing. A selection of an API indicator may be detected, the API indicator associated with one API of a plurality of APIs. A plurality of user interface control indicators may be displayed in response to the selection of the API indicator. The selection of a first user interface control indicator of the plurality of user interface control indicators may be detected, the first user interface control indicator associated with the graphical user interface control. The graphical user interface control may be compatible with the one API. An API call may be initiated using the one API. Response data may be received in response to the API call. The graphical user interface control may be displayed using at least a subset of the received response data.

### BACKGROUND

1. Field

The present disclosure relates to application development tools, and, in one particular example, to application development tools with an interactive list of application program interfaces.

2. Related Art

One of the main challenges in developing an enterprise application is efficiently using services provided by a backend system. These services are often exposed to application developers via application program interfaces (APIs). Understanding APIs, their proper use, and their visual implications is challenging and time-consuming.

Many current program development environments provide a static list of all APIs supported by a backend system. Typically, the program development environment describes an individual API and provides an exemplary program code snippet that uses the API. The description of the API specifies the proper syntax of the API, specifies and describes input parameters of the API, specifies and describes return values of the API, and provides usage requirements, such as system dependencies, for using the API.

The exemplary code snippet illustrates an example of using the API. The exemplary code snippet must be altered or customized in order to meet the needs of the developer, or to properly integrate with the rest of the source code the developer is writing. The exemplary code snippet may also contain comments within the source code. The comments may provide further details about the functions of the components of the exemplary code snippet, such as what additional or alternative options may be available.

### SUMMARY

Systems and processes for displaying a graphical user interface control are described. A plurality of API indicators may be displayed in response to a request for an API listing. A selection of an API indicator of the plurality of API indicators may be detected, where the API indicator is associated with one API of a plurality of APIs. A plurality of user interface control indicators may be displayed in response to the selection of the API indicator of the plurality of API indicators. The selection of a first user interface control indicator of the plurality of user interface control indicators may be detected, where the first user interface control indicator is associated with the graphical user interface control. The graphical user interface control may be compatible with the one API of the plurality of APIs associated with the API indicator. An API call may be initiated. The API call may use the one API of the plurality of APIs associated with the API indicator. Response data may be received in response to the API call. The graphical user interface control may be displayed, where the graphical user interface control uses at least a subset of the received response data.

The plurality of APIs may include a subset of supported APIs, where the subset of supported APIs is determined based on the availability of supported APIs. One or more of the plurality of API indicators may be associated with one or more APIs of the plurality of APIs. In one example, request data may be transmitted as part of initiating the API call and at least one of the request data and the response data may be displayed. The response data may be displayed based on a format selected from the group consisting of a raw format, a javascript object notation (JSON) format, and an extensible markup language (XML) format. The first user interface control indicator may be associated with a first computing code of a first computing language, and a second user interface control indicator of the plurality of user interface control indicators may be associated with a second computing code of a second computing language. A selection and a drag of the graphical user interface control may be detected, and at least a portion of the first computing code may be communicated to another application in response to detecting the selection and drag of the graphical user interface control.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary block diagram showing the relationship between a backend system and clients.

FIG. 2 illustrates an exemplary process for displaying a graphical user interface control, and accessing source code for the graphical user interface control.

FIG. 3 illustrates an exemplary development tool displaying an interactive list of API indicators.

FIG. 4 illustrates an exemplary development tool displaying response data received in response to an API listing request.

FIG. 5 illustrates an exemplary development tool displaying user interface control indicators that are compatible with a selected API.

FIG. 6 illustrates an exemplary development tool with a binding interface.

FIG. 7 illustrates an exemplary development tool displaying a fully functional graphical user interface control.

FIG. 8 illustrates an exemplary development tool displaying user interface source code used to generate a graphical user interface control.

FIG. 9 illustrates an exemplary development tool displaying modified user interface source code in a source code editor mode.

FIG. 10 illustrates an exemplary development tool displaying a fully functional graphical user interface control that has been modified using a source code editor mode.

FIG. 11 illustrates an exemplary computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

Various embodiments are described below relating to systems and processes for displaying a graphical user interface control. A plurality of API indicators may be displayed in response to a request for an API listing. A selection of an API indicator of the plurality of API indicators may be detected, where the API indicator is associated with one API of a plurality of APIs. A plurality of user interface control indicators may be displayed in response to the selection of the API indicator of the plurality of API indicators. The selection of a first user interface control indicator of the plurality of user interface control indicators may be detected, where the first user interface control indicator is associated with the graphical user interface control. The graphical user interface control may be compatible with the one API of the plurality of APIs associated with the API indicator. An API call may be initiated. The API call may use the one API of the plurality of APIs associated with the API indicator. Response data may be received in response to the API call. The graphical user interface control may be displayed, where the graphical user interface control uses at least a subset of the received response data.

The plurality of APIs may include a subset of supported APIs, where the subset of supported APIs is determined based on the availability of supported APIs. One or more of the plurality of API indicators may be associated with one or more APIs of the plurality of APIs. In one example, request data may be transmitted as part of initiating the API call and at least one of the request data and the response data may be displayed. The response data may be displayed based on a format selected from the group consisting of a raw format, a javascript object notation (JSON) format, and an extensible markup language (XML) format. The first user interface control indicator may be associated with a first computing code of a first computing language, and a second user interface control indicator of the plurality of user interface control indicators may be associated with a second computing code of a second computing language. A selection and a drag of the graphical user interface control may be detected, and at least a portion of the first computing code may be communicated to another application in response to detecting the selection and drag of the graphical user interface control.

An API is an interface between two computing components, such as a backend software component and a client software component. The two software components use the API to communicate with each other. For example, an API may be used to communicate variables, data structures, object classes, requests for information, instructions, and the like. Typical program development environments provide static documentation associated with an API and thus do not need to communicate with the backend that provides the API.

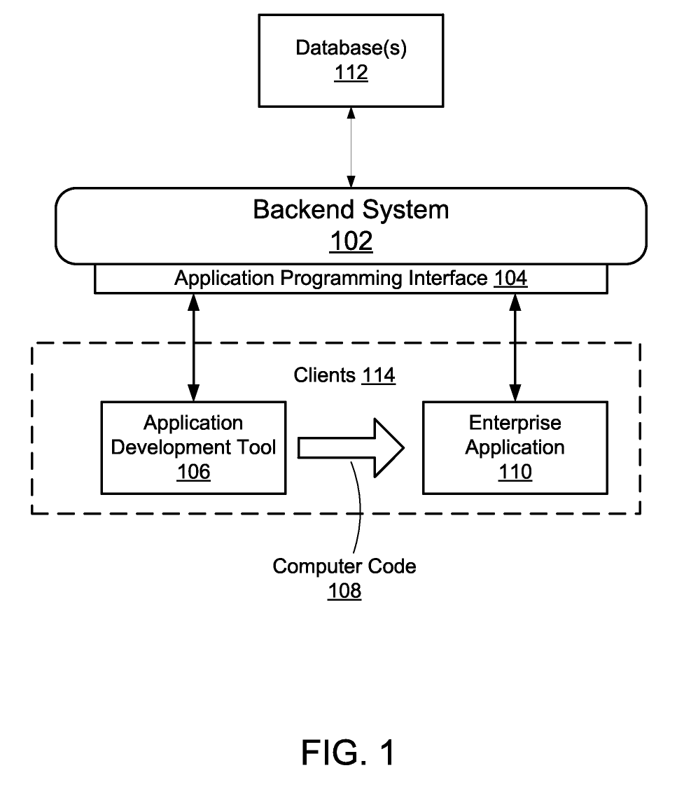

FIG. 1 illustrates an exemplary block diagram showing the relationship between a backend system 102 and clients 114. Unlike typical program development environments, the application development tool 106 communicates with the backend system 102 using API 104. The enterprise application 110 may be fully or partially programmed using the application development tool 106. For example, enterprise application 110 may be a web application that runs in a web browser, a program application that runs on a mobile device, an interpreted program that runs on a desktop computer, or the like.

In one example, application development tool 106 may make an API call to backend system 102 requesting an API listing. The backend system 102 may determine a list of APIs and return the list, as an API listing, to the application development tool 106 in response to the API listing request. In another example, backend system 102 may receive a request for a listing of available and/or supported APIs from the application development tool 106 via API 104. In response, the backend system 102 may determine the available and/or supported APIs and return the corresponding API listing. The application development tool 106 may use the API listing to determine the list of available and/or supported APIs.

For example, the API listing returned by the backend system may be a data structure that indicates which APIs are supported and which APIs are not supported. In another example, the API listing returned by the backend system may be used to specify which APIs are available and which APIs are not available. An API is supported when the backend system is configured to accept an API request associated with the API. The acceptance may be based on the credentials of the user associated with the API request. A user may further configure the application development tool 106 by selecting multiple desired APIs that the user expects to use—or wants displayed—while developing software using the application development tool 106. These selected APIs will be available to the user while developing an application using the application development tool 106. The APIs not selected will not be available to the user while the user is developing an application using the application development tool 106. For example, the APIs to be made available may be selected from among the APIs in the API listed returned by the backend system. In another example, the user can manually specify APIs to be made available without regard to the content of the API listing returned by the backend system. Further, the user may configure the application development tool 106 to change which APIs are available or are not available. Configuring the availability of APIs may, for example, provide the user with a more efficient and simple user interface for accessing APIs using the application development tool 106.

The backend system 102 may have access to one or more databases 112. The databases 112 may store data that the backend system 102 makes available to clients 114 through API 104. In one example, the backend system 102 and the databases 112 may be running on the same server. In another example, the backend system 102 and the databases 112 may be running on different servers. In yet another example, clients 114 may be running on the same server as the backend system 102 and the databases 112. In another example, each of the clients 114, the backend system 102, and the databases 112 may be running on different servers. One of skill in the art will appreciate that other variations may also work.

The backend system 102 may be configured to support many APIs. However, application development tool 106 and enterprise application 110 may only have access to a subset of the supported API 104. For example, backend system 102 may be configured to run only certain services associated with certain APIs. When the application development tool 106 connects to the backend system 102 and requests a listing of available APIs, the backend system 102 may return only a subset of the list of APIs associated with the services that are currently running. In another example, a user account may be restricted from accessing certain APIs. The backend system 102 may return a list of a subset of the list of APIs associated with running services based on the restrictions imposed on the user account. Thus, the subset of the list of APIs will include only the APIs that are both associated with running services and not restricted for the requesting user account. The restriction may be based on, for example, a geographical location of the client 114 requesting the API listing, a user status associated with the client 114 requesting the API listing, the compatibility of the software environment of the client 114 requesting the API listing, and the like.

Similarly, enterprise application 110, which is developed using application development tool 106, may also access the backend system 102 using the API 104. If the same user account is associated with both application development tool 106 and enterprise application 110, the same APIs may be supported and/or available to both the clients. However, the purpose of the application development tool 106 and the enterprise application 110 may be different. The application development tool 106 may be used to develop the enterprise application 110. The application development tool 106 may provide a development interface that allows a developer to view API listings, API descriptions, graphical user interface controls, computer code, and the like; these items may aid in the development of software applications, such as enterprise application 110. In contrast, enterprise application 110 may be, for example, an enterprise software solution that uses API 104 to access the functionality of backend system 102. This may include reading and writing data to databases 112.

The application development tool 106 may generate or select computer code 108, which is used to develop enterprise application 110. Computer code 108 may include program source code, such as C, C++, Pascal, Assembly code, or any other program source code in any computer language. Computer code may also include markup code, such as hypertext markup language (html), extensible markup language (XML), xhtml, css, vector graphics markup language, or any other markup code in any computer language. In one example, the computer code 108 may be used directly by the application development tool 106, such as by performing all or some of the steps necessary for creating a computer application or computer display, in order to aid a user in the development of enterprise application 110. These steps may include interpreting, compiling, assembling, linking, and/or loading the computer code 108. In another example, the computer code 108 may be copied or transferred to a different development tool or system to aid in the development of enterprise application 110.

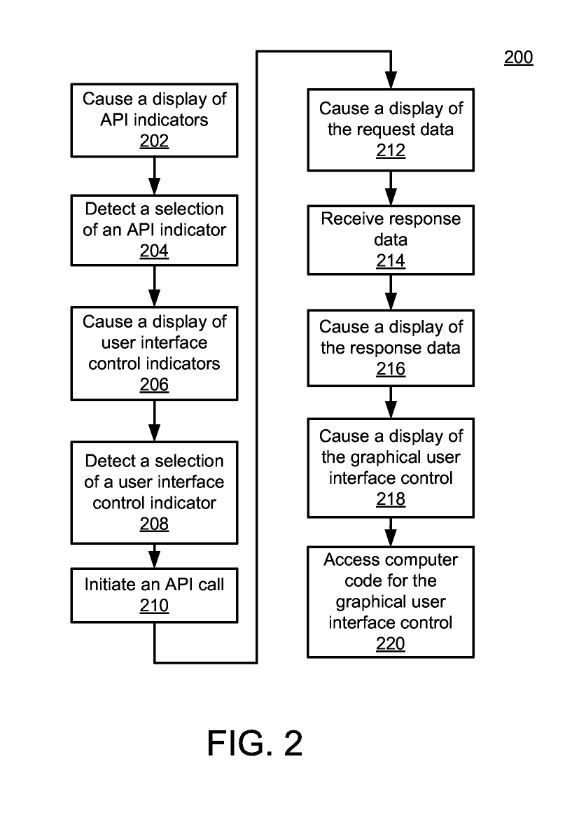

FIG. 2 illustrates an exemplary process 200 for displaying a graphical user interface control, and accessing computer code, such as source code, for the graphical user interface control. In block 202, the system causes a display of multiple API indicators. An API indicator may be text that describes or identifies an API, an image that represents an API, or the like. The display of the multiple API indicators may be based on receiving response data from a backend system in response to an API listing request. The response to the API listing request may include a representational state transfer (REST) API, an entity type, a request method, a description, and API parameters. For example, the response to the API listing request may include multiple REST APIs, with each REST API being associated with an entity type, a request method, a description, and API parameters.

In one example, the system may be accessed when a user logs into the system using a username and/or a password. Using the login information, the system may set system preferences based on the username or other login information. Once the user logs in, the system may request an API listing from a backend system. In response to the API listing request, the backend system may determine the APIs that the user has access to, and return an API listing of these APIs. Upon receiving the API listing, the system may display multiple API indicators. In one example, each API indicator has a one-to-one association with each API in the API listing. Thus, the system may display a list of the APIs, with each entry in the list associated with one API in the API listing. In another example, more than one API indicator may be associated with one API.

In block 204, the system detects a selection of an API indicator. A user may select one of the API indicators using a computer input device, such as a mouse or keyboard. Thus, in one example, the user may select an API indicator using a keyboard by typing the full text displayed as part of the API indicator. In another example, the user may select an API indicator by navigating a mouse cursor over an image serving as an API indicator and pressing a selection button or buttons, and the system detects the API indicator selected by the user. One of skill in the art will readily appreciate that there are many other ways that a user may select an API indicator.

In block 206, the system causes a display of user interface control indicators. A user interface control indicator may be text that describes or identifies a type of user interface control, an image that represents a type of user interface control, or the like. The system may cause the display of user interface control indicators in response to detecting the selection of the API indicator. In one example, when the selected API indicator is associated with an API, the system may cause only the display of user interface control indicators that are compatible with the API. In another example, when the selected API indicator is associated with an API, the system may display all user interface control indicators, but mark or otherwise identify the user interface control indicators that are compatible with the API. The system may also provide a user-selectable option that allows the user to switch between viewing all user interface control indicators, or viewing only user interface control indicators that are compatible with the selected API. Viewing only compatible user interface control indicators may allow the user to quickly determine which user interface controls are designed to interface with the selected API.

A user interface control may be determined to be compatible with an API when the user interface control uses the same number of attributes and the same type of data as the API is expected to return. The entity properties of the API may be used to determine the compatibility of the API with a user interface control. The entity properties information may be received or determined based on a response to an API request. For example, the entity properties may include the number of attributes and the data type of the attributes returned in response to an API request.

At block 208, the system detects a selection of a user interface control indicator. A user may select one of the user interface control indicators using a computer input device, such as a mouse or keyboard. In one example, the user may select the user interface control indicator using a keyboard by typing the full text displayed as part of the user interface control indicator. In another example, the user may select the user interface control indicator by navigating a mouse cursor over an image serving as a user interface control indicator and pressing a selection button or buttons. One of skill in the art will readily appreciate that a user interface control indicator may be selected using other methods.

If the user selects a user interface control indicator associated with a user interface control that is not compatible with the selected API, the system may prompt the user to manually bind the attributes of the API to the required attributes of the user interface control. For example, consider a user interface control, named “HTML username display,” configured to display an html table with two columns, the first column indicating a username attribute, and the second column indicating an email address attribute that corresponds to the username. The user interface control indicator associated with the HTML username display user interface control may not be compatible with an API that returns attributes including the users' identification numbers, corresponding access permission level, and corresponding join dates. However, the user may manually bind the attributes of the API to the required attributes of the user interface control.

In this example, the required attributes of the user interface control may be the username attribute and the email address attribute. The user may access the binding interface to bind the attributes of the API to the required attributes of the user interface control. The user may bind the identification number attribute of the API to the username attribute of the user interface control. Similarly, the user may bind the join-date attribute of the API to the email address attribute of the HTML username display user interface control. Thus, the user interface control will include data relating to the identification number attribute and join-date attribute of the API. The corresponding access permission level attribute may not be represented in the user interface control if the user does not bind that attribute to any attribute of the user interface control. In another example, the user could bind the same attribute of the API to multiple attributes of a user interface control.

Although the above example describes a scenario where a user binds attributes between an incompatible API and a user interface control, a user may also bind attributes of a compatible API and a user interface control to meet the user's preferences.

At block 210, the system initiates an API call to the backend system. The called API may be the API associated with the selected API indicator. In order to make the API call, the system may need to provide request data to the backend system. The request data may include a request header and a request body. For example, the request data may include information such as the called API, the IP of the backend system, requestor information, the username of the user logged in, session information, API-specific request attribute data, and the like. The backend system may use all or some of the request data when processing the API request.

At block 212, the system causes a display of the request data. The request data may be displayed to allow the user to more easily debug the request initiated to the backend system. The request data may be displayed in raw format, based on XML formatting, based on javascript object notation (JSON) formatting, or the like.

At block 214, the system receives response data in response to the API call. The response data may include a response header and a response body. For example, the response data may include information such as the length of the response body, the content-type of the response body, name-value pairs, and the like. The contents of a response body may vary based on the API called. The response body of a GET request may include entity data objects, such as name-value pairs. The response body of a POST, PUT, or DELETE request may result in no response body or a response body with no content. Instead, for a POST, PUT, or DELETE request, the response header may specify which entity was created, modified, deleted, or the like.

At block 216, the system causes a display of the response data. The response data may be displayed to allow the user to more easily debug the response received from the backend system. The response data may be displayed in raw format, based on XML formatting, based on JSON formatting, or the like.

At block 218, the system causes a display of the graphical user interface control. The graphical user interface control is associated with the selected user interface control indicator and is based on computer code. The graphical user interface control may incorporate some or all of the response data received from the backend system.

At block 220, the system accesses computer code for the graphical user interface control. The computer code, when used outside of the system, may result in the display of the graphical user interface control. The computer code may be displayed for the user to view or modify. Modifying the computer code may allow the user to view the corresponding change in the graphical user interface control before using the computer code in an external enterprise application.

In one example, the user can switch between displaying the graphical user interface control and the computer code. If the user changes the computer code, the graphical user interface control will reflect the changes the next time it is viewed by the user. If the computer code is changed such that the computer code contains improper programming syntax, the system may display an error message when the user attempts to view the graphical user interface control. In another example, the user can view the graphical user interface control and the associated computer code simultaneously. If the user changes the computer code, the displayed graphical user interface control will reflect the changes in near real-time.

In general, the blocks of FIG. 2 may be performed in various orders, and in some instances may be performed partially or fully in parallel. For example, an API call may be initiated, as described in block 210, before the system detects the selection of a user interface control indicator, as described in block 208. In another example, blocks 216 and 218 may be performed fully in parallel. Additionally, not all blocks must be performed. For example, the system may not cause the display of the request data of block 212 and may not cause the display of the response data of block 216.

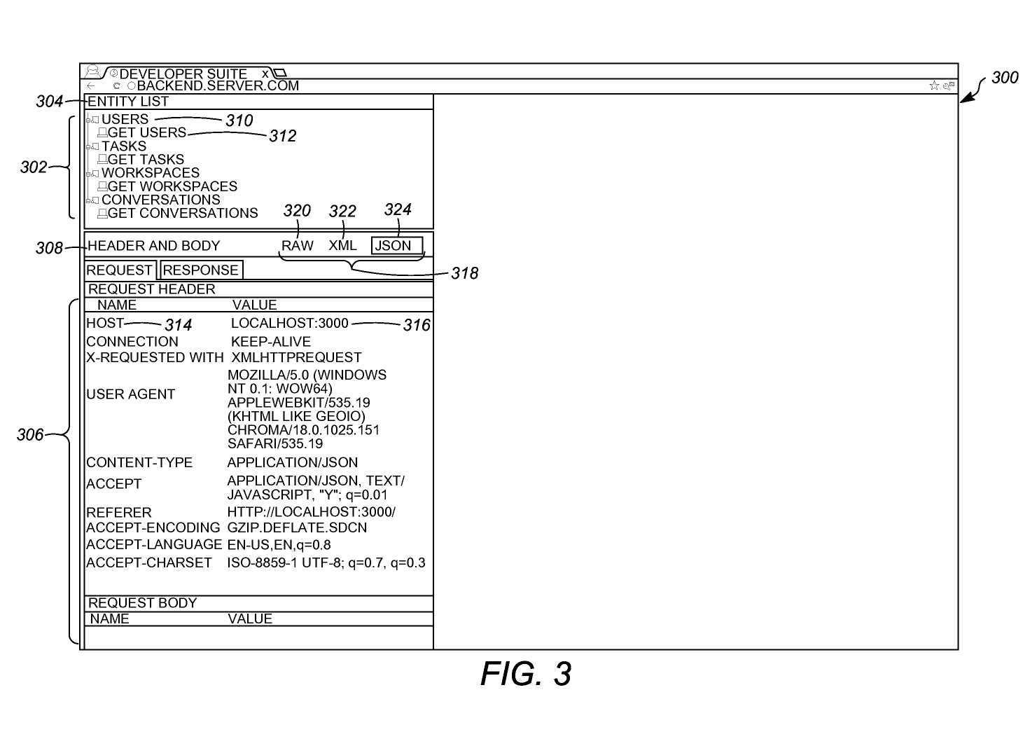

FIG. 3 illustrates an exemplary development tool 300 displaying an interactive list of API indicators 302 in entity list pane 304. The development tool 300 has previously requested an API listing from a backend system. The API listing may be requested, for example, when development tool 300 is first started, when development tool 300 is initially accessed, at the user's instruction, and the like. In response to the API listing request, development tool 300 has received an API listing. In this example, each of the API indicators 302 displayed has a one-to-one correspondence with an API from the received API listing.

By viewing the API indicators 302, a user can readily appreciate that the received API listing contains four APIs, with each API of the API listing associated with a displayed API indicator of API indicators 302. The API indicators 302 may be organized in a hierarchical manner. For example, the Get Users API indicator 312 may be associated with a GetUsers API, which may be used to request listings of users from the backend system. The GetUsers API indicator 312 may be organized under the Users folder 310. Users folder 310 may contain the subset of API indicators 302 that are related to requesting user information. For example, if the system supported a GetUserDetails API, a corresponding Get User Details API indicator may also be organized under Users folder 310. In one example, the development tool 300 determines the hierarchical structure of the API indicators 302. In another example, the hierarchical structure of the API listing may be based on the response data the development tool 300 receives from the backend system in response to the API listing request.

The request data 306 is displayed in the Header and Body pane 308. In this example, the request data 306 includes multiple name-value pairs. For example, the host key 314 is assigned a host key value 316 of localhost:3000. The request data 306 may be displayed to allow the user to more easily debug the request initiated to the backend system.

The request data 306 may be displayed in raw format, based on XML formatting, based on JSON formatting, or the like. When the request data 306 is compatible with more than one display format, development tool 300 may provide a user-selectable display format option 318 for selecting among the display formats. In this example, the request data 306 is compatible with both the raw format and the JSON format. Thus, the user can select the raw option 320 or the JSON format option 324. In this example, the request data 306 is not compatible with the XML format. Thus, the XML format option 322 is grayed out, which indicates that the XML format option 322 cannot currently be selected by the user.

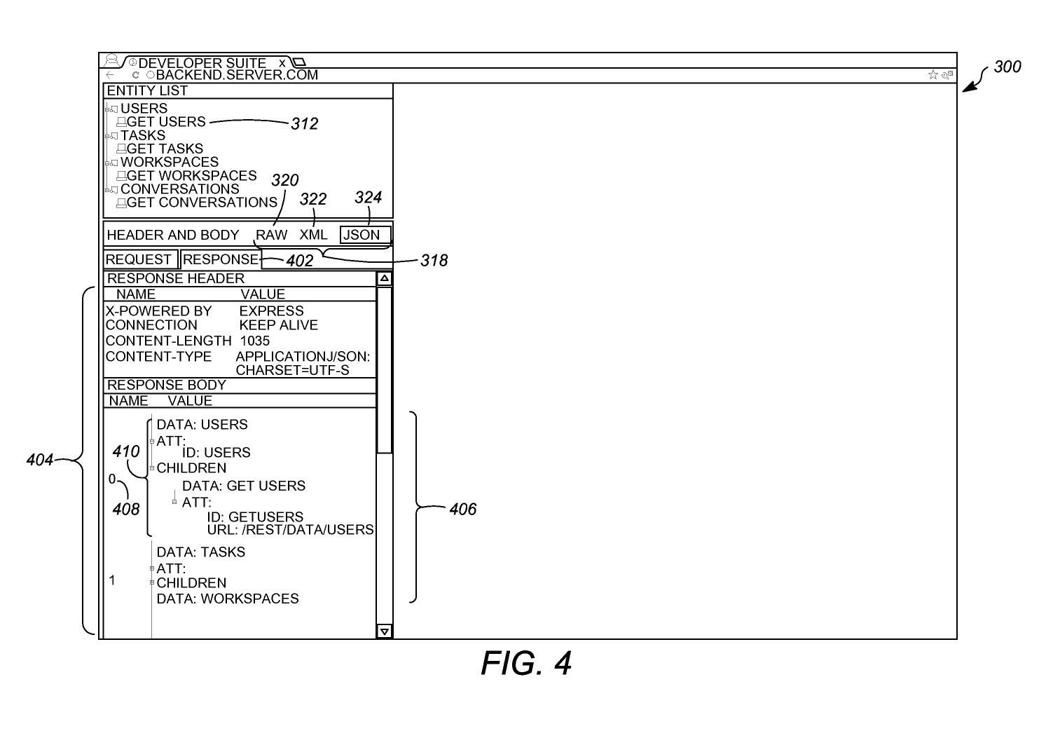

FIG. 4 illustrates the exemplary development tool 300 displaying response data 404 received in response to an API listing request. The user may switch to the response data view by selecting response tab 402. Similar to the request data view, development tool 300 may provide user-selectable display format options 318 in the response data view for selecting among multiple display formats. In this example, the response data 404 is compatible with both the raw format and the JSON format. Thus, the user can select the raw option 320 or the JSON format option 324. Because in this example the response data 404 is not compatible with the XML format, the XML format option 322 is grayed out.

Response body 406 of the response data 404 illustrates an example of displaying data based on the JSON format option 324. The response body 406 may be organized in a hierarchical manner. As illustrated, the name 408 has a value of 0. Name 408 is associated with the value 410. Value 410 includes a “Get Users” child, which is associated with the GetUsers identification and URL of “/rest/data/users.” This information is used when displaying the Get Users API indicator 312, which is associated with the GetUsers API.

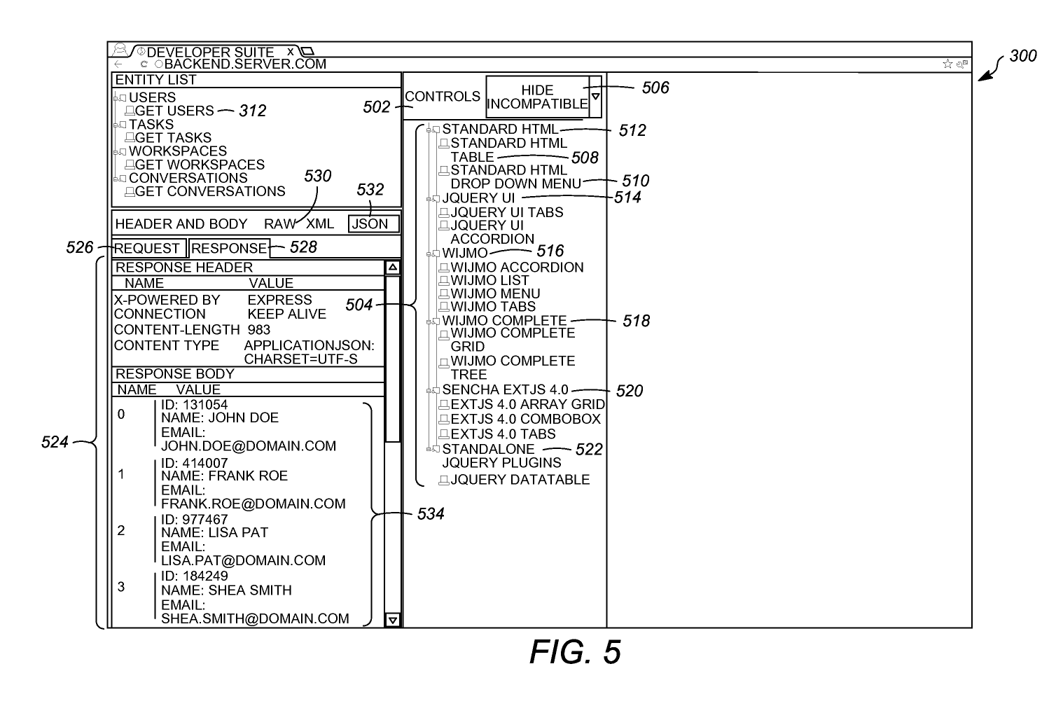

FIG. 5 illustrates an exemplary development tool 300 displaying user interface control indicators 504 that are compatible with the API associated with selected API indicator 312. When a user selects the Get Users API indicator 312, the system detects the selection and displays the user interface control indicators 504 in the Controls pane 502. In this example, development tool 300 provides a user-selectable compatibility display option 506 for selecting among compatibility options. The user has selected a compatibility display option that hides user interface control indicators associated with user interface controls that are incompatible with the selected API indicator 312, as illustrated by the “Hide Incompatible” selection of the compatibility display option 506. Other options may also be available. In one example, the user may also select a compatibility display option 506 that displays all available user interface control indicators, regardless of whether their associated user interface control is compatible with the selected Get Users API indicator 312. In another example, the user may select a compatibility display option 506 that displays all user interface control indicators, but marks or otherwise identifies the user interface control indicators that are compatible with the selected Get Users API indicator 312.

A user interface control may be determined to be compatible with an API when the user interface control uses the same number of attributes and the same type of data as the API is expected to return. The entity properties of the API may be used to determine the compatibility of the API with a user interface control. The entity properties information may be received or determined based on a response to an API request. For example, the entity properties may include the number of attributes and the data type of the attributes returned in response to an API request.

The user interface control indicators 504 may have a one-to-one relationship with a type of user interface control. A user interface control type may be, for example, specific to a computer language and a visual style. For example, selecting standard html table user interface control indicator 508 may produce a graphical user interface including a graphical table based on the html computer language. In comparison, selecting standard html drop down menu user interface control indicator 510 may produce a graphical user interface including a graphical menu with a drop down list. When the drop down list is activated by a user, it displays multiple options, from which the user can select one. When the drop down list is inactive, the drop down list only displays the selected option.

User interface control indicators 504 may be organized in a hierarchical manner. For example, all user interface control indicators associated with user interface controls that use a specific computer language, or a specific version of a computer language, may be grouped together. Expandable directory 512 labeled as “standard HTML” illustrates this concept. The standard HTML directory 512 includes all interface control indicators that are associated with user interface controls that use the standard HTML computer language. Further, because the “Hide Incompatible” option is selected in compatibility display option 506, only user interface control indicators that are associated with user interface controls that both use the standard HTML computer language and are compatible with the selected Get Users API indicator 312 are displayed with the standard HTML directory 512. This includes standard html table user interface control indicator 508 and standard html drop down menu user interface control indicator 510. One of ordinary skill in the art will readily appreciate that the user interface control indicators may be organized in a variety of manners.

In this example, Controls pane 502 also includes a JQuery UI directory 514, a Wijmo directory 516, a Wijmo complete directory 518, a Sencha ExtJS 4.0 directory 520, and a standalone JQuery plugins directory 522. These directories may be used to further organize user interface control indicators 504.

Development tool 300 may also make an API call to the backend system in response to detecting the selection of the Get Users API indicator 312. The request data transmitted in the API call and/or the response data 524 received in response to the API call may be displayed in development tool 300. In this example, a user may switch between viewing the request data and the response data 524, by selecting between request tab 526 and response tab 528.

In this example, the response body 534 of response data 524 is compatible with both the raw format and the JSON format. Thus, the user can select the raw option 530 or the JSON format option 532. Because the response data 524 in this example is not compatible with the XML format, the XML format option is grayed out.

Response body 534 of the response data 524 illustrates an example of displaying response data based on the JSON format option 532. As illustrated, the response from the backend system may include multiple name-value pairs. In this example, each name is a numbered identifier that is associated with an identification, full name, and email address of a user. The information in the response body 534 of the response data 524 may be used to display a graphical user interface control when the user selects a user interface control indicator from among user interface control indicators 504.

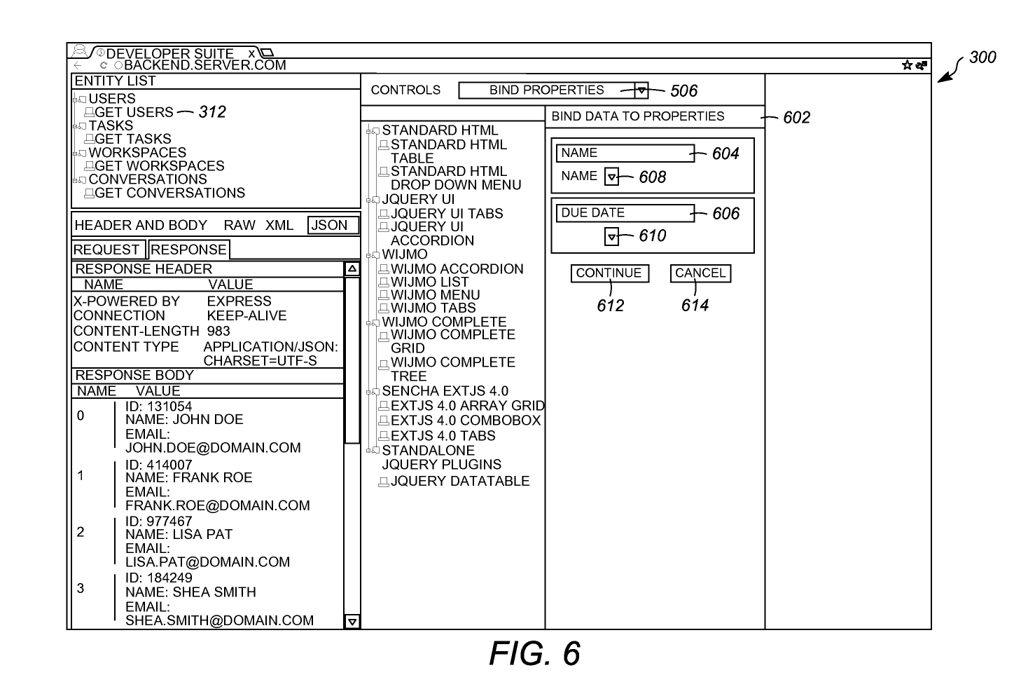

FIG. 6 illustrates an exemplary development tool 300 with a binding interface 602. The binding interface 602 may be invoked by, for example, selecting a “bind properties” option from the user-selectable compatibility display option 506 or by selecting a user interface control indicator that is not compatible with the API associated with the selected API indicator 312. The user may use the binding interface 602 to bind an attribute of an API to the attribute of a user interface control. Binding may be an optional step or a required step. For example, binding may be optional when the API associated with the selected API indicator 312 is compatible with the selected user interface control indicator. In another example, binding may be required when the API associated with the selected API indicator 312 is not compatible with the selected user interface control indicator.

A user may change the display name associated with an attribute of a user interface control. The user may make the change using user interface control attribute name inputs 604 and 606. In one example, each attribute of a user interface control may be associated with a corresponding user interface control attribute name input. The user may select an attribute of the API using drop down menus 608 and 610 for binding with a user interface control attribute. In another example, the user may only have access to bind certain attributes of the user interface control. After the user has made changes to the binding between attributes, the user may select the continue button 612 as a confirmation for the development tool 300 to apply the changes. Alternatively, the user may select the cancel button 614 to cancel the binding operation without applying any changes.

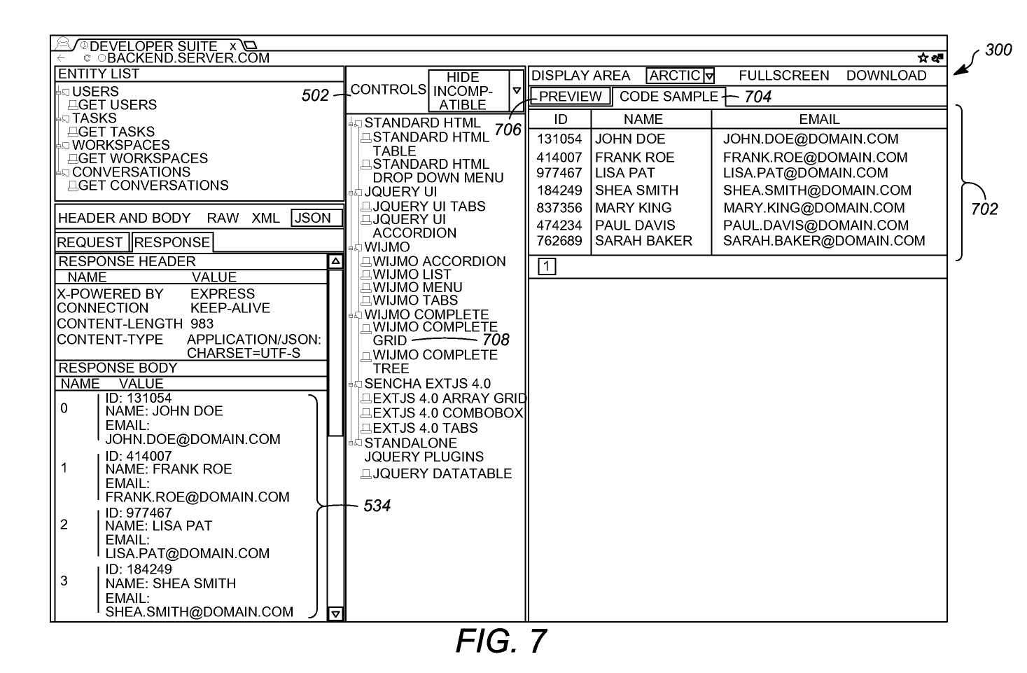

FIG. 7 illustrates an exemplary development tool 300 displaying a fully functional graphical user interface control 702 in a preview tab 706 of display pane 704. The graphical user interface control 702 is fully functional and uses the response data received in response to the API call. The computer language and/or the visual style of graphical user interface control 702 may be determined based on the user interface control indicator 708 selected in the Controls pane 502. In one example, the graphical user interface control 702 may display all or a portion of the response data received in response to the API call.

In this example, information similar to that displayed in response body 534 is formatted and displayed in the graphical user interface control 702. Many advantages are achieved by displaying actual response data received from the backend system in the graphical user interface control 702. For example, the user may view the visual characteristics of the graphical user interface control 702 while incorporating actual data from the backend system that is relevant to the user. More specifically, the user may view how the content will be structured and how the content may interact with the graphical user interface control, such as in the case when the user interface control includes a drop down menu.

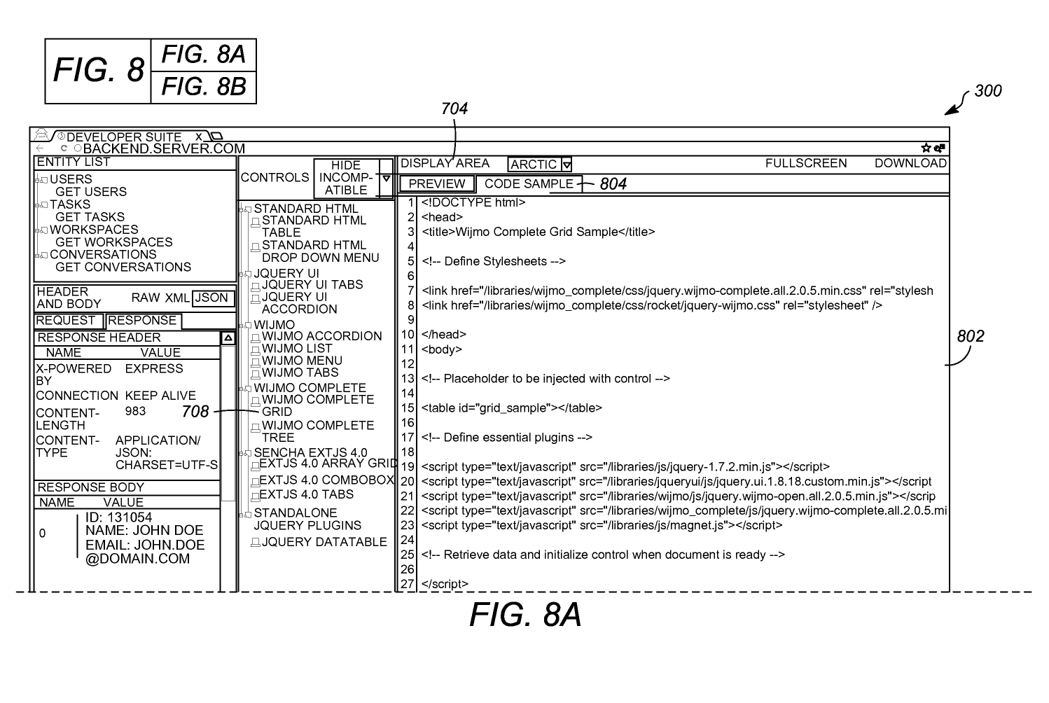

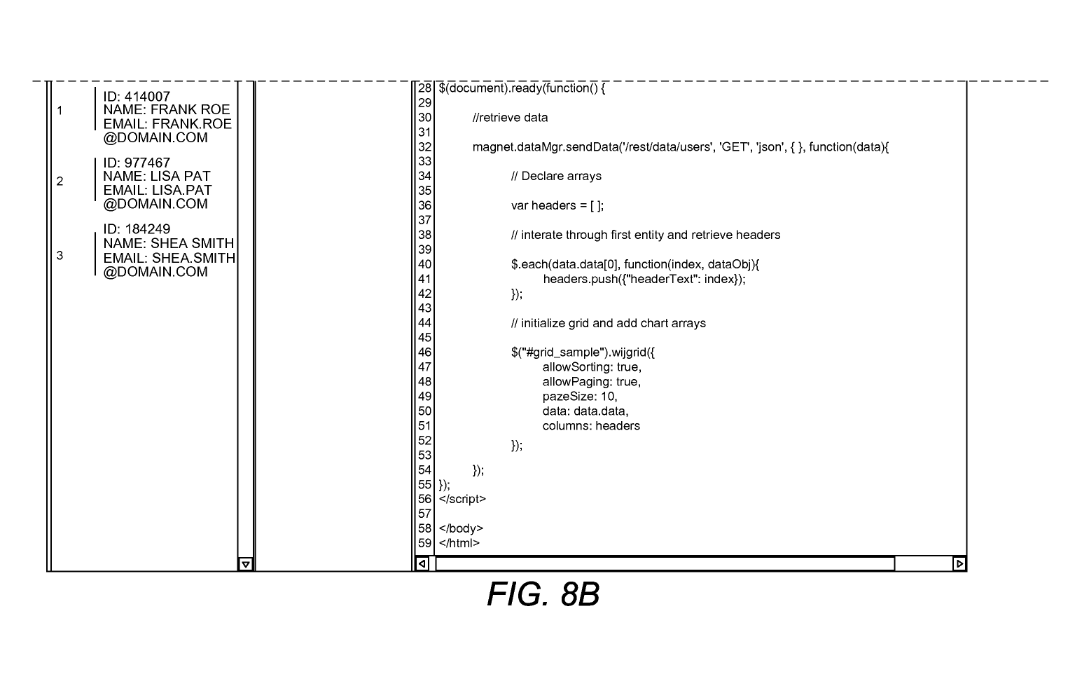

FIG. 8 illustrates an exemplary development tool 300 displaying user interface computer code 802 used to generate the graphical user interface control 702 of FIG. 7. Development tool 300 displays the functional user interface computer code 802 in code sample tab 804 of display pane 704. The user interface computer code 802 may be copied out of the development tool 300 and used to display the user interface control 702 of FIG. 7 in other development environments. For example, the user may copy all or a portion of user interface computer code 802 into existing computer source code.

The user may also modify the user interface computer code 802 in code sample tab 804. This may be done, for example, directly in code sample tab 804 of display pane 704. Development tool 300 may also provide functionality that aids a user in modifying the user interface computer code 802. For example, development tool 300 may provide syntax highlighting, bracket matching functionality, and the like. Syntax highlighting may include displaying portions of the user interface computer code 802 using different colors and fonts based on the syntax of the user interface computer code 802 being displayed. Bracket matching functionality may include highlighting or otherwise emphasizing matching sets of brackets or braces. In one example, development tool 300 determines the appropriate syntax of the user interface computer code 802 based on the content of user interface computer code 802 before applying the syntax highlighting or bracket matching functionality. In another example, development tool 300 determines the appropriate syntax of the user interface computer code 802 based on the selected user interface control indicator 708.

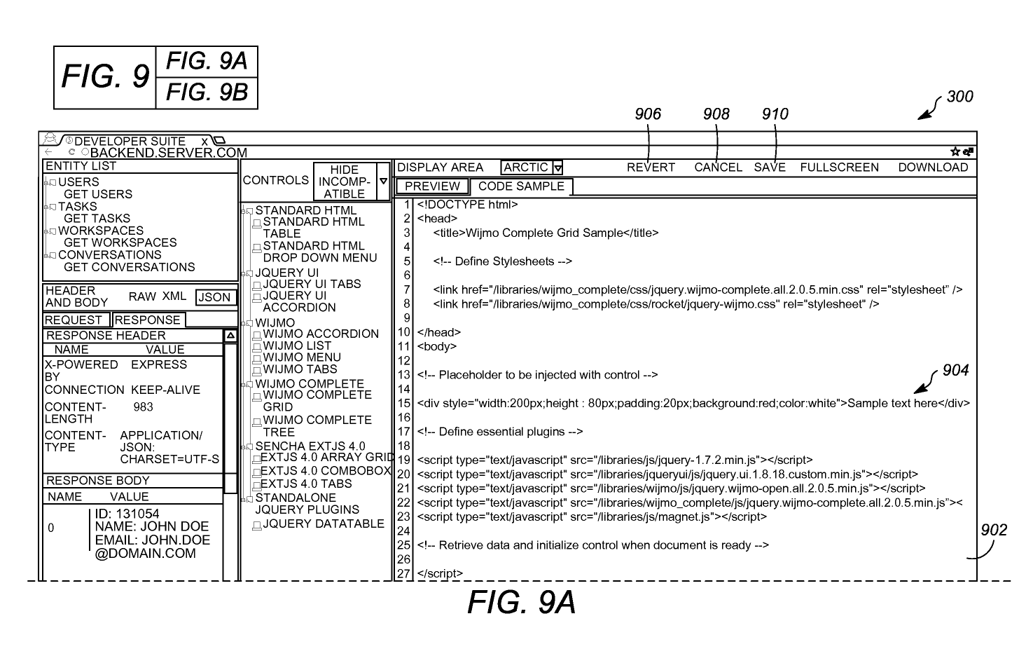

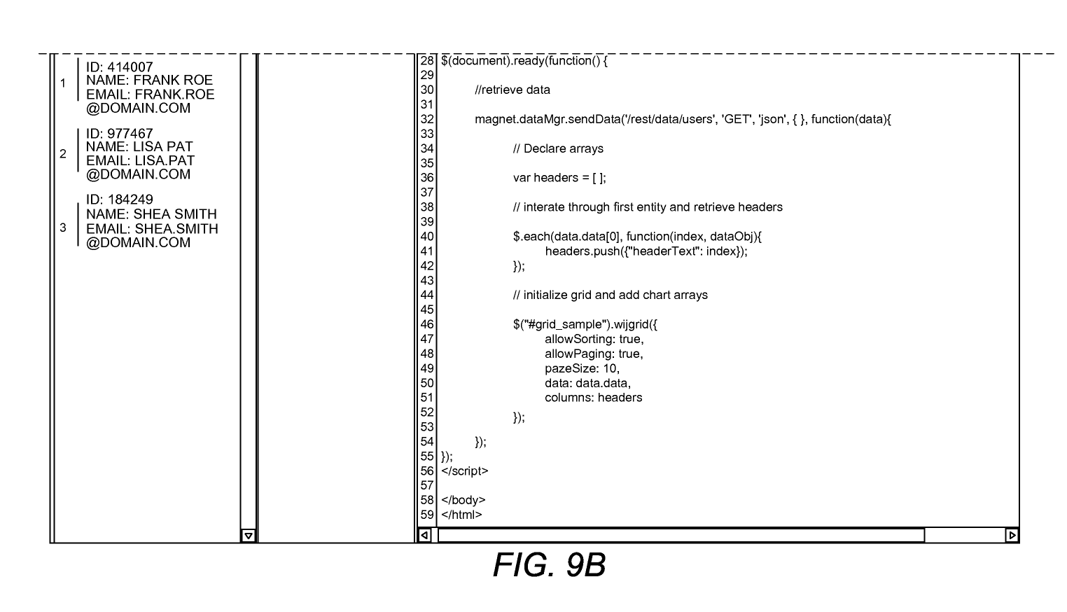

FIG. 9 illustrates an exemplary development tool 300 displaying a modified user interface computer code 902 in a computer code editor mode. The user may initiate the computer code editor mode by placing a pointing device over the computer code and making a selection. For example, the user may move a mouse cursor over the user interface computer code 902 and click. The user may then modify the user interface computer code 902 by, for example, adding, changing, replacing, or deleting code. FIG. 9 illustrates a modification in the computer code at modified computer code 904.

After the computer code has been modified, the user is prompted with several options, including revert option 906, cancel option 908, and save option 910. In one example, selecting revert option 906 may cause the user interface computer code 902 to revert to the original, unmodified version of the computer code. In another example, selecting revert option 906 may cause the user interface computer code 902 to revert to the last saved version of the modified user interface computer code. Selecting cancel option 908 may cause development tool 300 to exit the computer code editor mode and abandon all unsaved changes to user interface computer code 902. Selecting save option 910 may cause development tool 300 to write the modified user interface computer code 902 to memory.

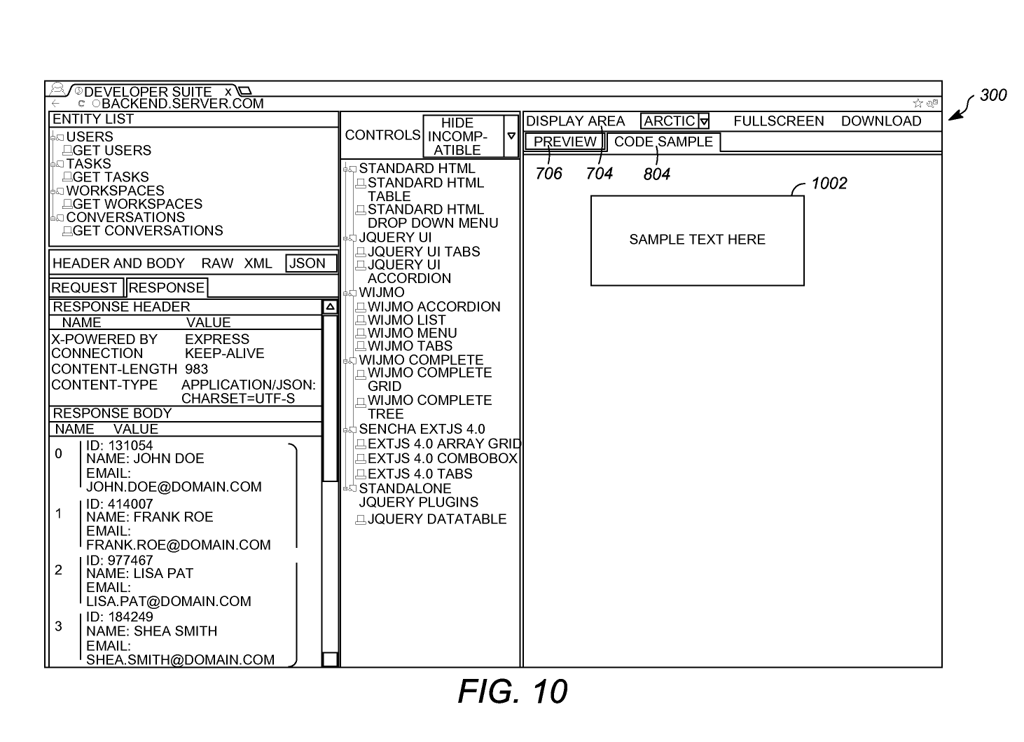

FIG. 10 illustrates an exemplary development tool 300 displaying a fully functional graphical user interface control in preview tab 706. The user may return to the preview tab 706 of display pane 704 by selecting the preview tab 706. The preview tab includes the modified graphical user interface control 1002, which is based on the modified user interface computer code. This allows the user to modify the user interface computer code 802 of FIG. 8 and to easily view the corresponding changes in the graphical user interface control before using the modified user interface computer code 902 of FIG. 9 in an external enterprise application. The user may make additional changes by returning to the computer code editor mode of the code sample tab 804.

As described above, the user may copy the computer code to another development tool, or directly insert the computer code into existing source code. The user may also drag the modified graphical user interface control 1002 out of preview tab 706 of display pane 704 and drop it into another development tool. The user may also drag the modified graphical user interface control 1002 out of preview tab 706 and drop it directly into existing source code of an enterprise application. This allows the user to have an accurate understanding of what the graphical user interface control will look like when the graphical user interface control is deployed in the enterprise application.

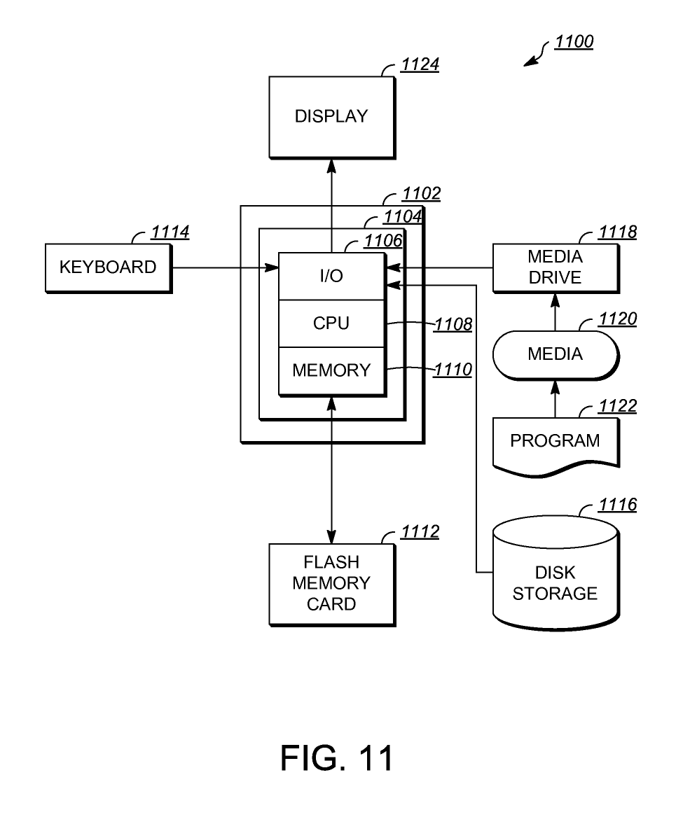

FIG. 11 depicts an exemplary computing system 1100 configured to perform any one of the above-described processes. In this context, computing system 1100 may include, for example, a processor, memory, storage, and input/output devices (e.g., monitor, keyboard, disk drive, Internet connection, etc.). However, computing system 1100 may include circuitry or other specialized hardware for carrying out some or all aspects of the processes. In some operational settings, computing system 1100 may be configured as a system that includes one or more units, each of which is configured to carry out some aspects of the processes either in software, hardware, or some combination thereof.

FIG. 11 depicts computing system 1100 with a number of components that may be used to perform the above-described processes. The main system 1102 includes a motherboard 1104 having an input/output (“I/O”) section 1106, one or more central processing units (“CPU”) 1108, and a memory section 1110, which may have a flash memory card 1112 related to it. The I/O section 1106 is connected to a display 1124, a keyboard 1114, a disk storage unit 1116, and a media drive unit 1118. The media drive unit 1118 can read/write a computer-readable medium 1120, which can contain programs 1122 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Although only certain exemplary embodiments have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. A computer-enabled method for displaying a graphical user interface control, the method comprising:
causing a display of a plurality of API indicators in response to a request for an API listing;
detecting a selection of an API indicator of the plurality of API indicators, the API indicator associated with one API of a plurality of APIs;
causing a display of a plurality of user interface control indicators in response to the selection of the API indicator of the plurality of API indicators;
detecting a selection of a first user interface control indicator of the plurality of user interface control indicators, the first user interface control indicator associated with the graphical user interface control, wherein the graphical user interface control is compatible with the one API of the plurality of APIs associated with the API indicator;
initiating an API call, the API call using the one API of the plurality of APIs associated with the API indicator;
receiving response data in response to the API call; and
causing a display of the graphical user interface control, the graphical user interface control using at least a subset of the received response data.

2. The computer-enabled method of claim 1, wherein the plurality of APIs includes a subset of supported APIs, the subset of supported APIs determined based on the availability of supported APIs.

3. The computer-enabled method of claim 1, wherein each of the plurality of API indicators are associated with one or more APIs of the plurality of APIs.

4. The computer-enabled method of claim 2, further comprising:
transmitting request data as part of initiating the API call; and
causing a display of at least one of the request data and the response data.

5. The computer-enabled method of claim 4, wherein the response data is caused to be displayed based on a format selected from the group consisting of a raw format, a javascript object notation (JSON) format, and an extensible markup language (XML) format.

6. The computer-enabled method of claim 4, wherein:
the first user interface control indicator is associated with a first computing code of a first computing language; and
a second user interface control indicator of the plurality of user interface control indicators is associated with a second computing code of a second computing language.

7. The computer-enabled method of claim 4, further comprising:
detecting a selection and drag of the graphical user interface control; and
communicating at least a portion of the first computing code in response to detecting the selection and drag of the graphical user interface control.

8. A non-transitory computer-readable storage medium comprising computer-executable instructions for displaying a graphical user interface control, the instructions comprising:
causing a display of a plurality of API indicators in response to a request for an API listing;
detecting a selection of an API indicator of the plurality of API indicators, the API indicator associated with one API of a plurality of APIs;
causing a display of a plurality of user interface control indicators in response to the selection of the API indicator of the plurality of API indicators;
detecting a selection of a first user interface control indicator of the plurality of user interface control indicators, the first user interface control indicator associated with the graphical user interface control, wherein the graphical user interface control is compatible with the one API of the plurality of APIs associated with the API indicator;
initiating an API call, the API call using the one API of the plurality of APIs associated with the API indicator;
receiving response data in response to the API call; and
causing a display of the graphical user interface control, the graphical user interface control using at least a subset of the received response data.

9. The non-transitory computer-readable storage medium of claim 8, wherein the plurality of APIs includes a subset of supported APIs, the subset of supported APIs determined based on the availability of supported APIs.

10. The non-transitory computer-readable storage medium of claim 8, wherein each of the plurality of API indicators are associated with one or more APIs of the plurality of APIs.

11. The non-transitory computer-readable storage medium of claim 9, further comprising:
transmitting request data as part of initiating the API call; and
causing a display of at least one of the request data and the response data.

12. The non-transitory computer-readable storage medium of claim 11, wherein the response data is caused to be displayed based on a format selected from the group consisting of a raw format, a javascript object notation (JSON) format, and an extensible markup language (XML) format.

13. The non-transitory computer-readable storage medium of claim 11, wherein:
the first user interface control indicator is associated with a first computing code of a first computing language; and
a second user interface control indicator of the plurality of user interface control indicators is associated with a second computing code of a second computing language.

14. The non-transitory computer-readable storage medium of claim 11, further comprising:
detecting a selection and drag of the graphical user interface control; and
communicating at least a portion of the first computing code in response to detecting the selection and drag of the graphical user interface control.

15. An apparatus for displaying a graphical user interface control, the apparatus comprising:
a memory configured to store data; and
a computer processor configured to:
cause a display of a plurality of API indicators in response to a request for an API listing;
detect a selection of an API indicator of the plurality of API indicators, the API indicator associated with one API of a plurality of APIs;
cause a display of a plurality of user interface control indicators in response to the selection of the API indicator of the plurality of API indicators;
detect a selection of a first user interface control indicator of the plurality of user interface control indicators, the first user interface control indicator associated with the graphical user interface control, wherein the graphical user interface control is compatible with the one API of the plurality of APIs associated with the API indicator;
initiate an API call, the API call using the one API of the plurality of APIs associated with the API indicator;
receive response data in response to the API call; and
cause a display of the graphical user interface control, the graphical user interface control using at least a subset of the received response data.

16. The apparatus of claim 15, wherein the plurality of APIs includes a subset of supported APIs, the subset of supported APIs determined based on the availability of supported APIs.

17. The apparatus of claim 15, wherein each of the plurality of API indicators are associated with one or more APIs of the plurality of APIs.

18. The apparatus of claim 16, wherein the computer processor is further configured to:
transmit request data as part of initiating the API call; and
cause a display of at least one of the request data and the response data.

19. The apparatus of claim 18, wherein the response data is caused to be displayed based on a format selected from the group consisting of a raw format, a javascript object notation (JSON) format, and an extensible markup language (XML) format.

20. The apparatus of claim 18, wherein:
the first user interface control indicator is associated with a first computing code of a first computing language; and
a second user interface control indicator of the plurality of user interface control indicators is associated with a second computing code of a second computing language.

21. The apparatus of claim 18, wherein the computer processor is further configured to:
detect a selection and drag of the graphical user interface control; and
communicate at least a portion of the first computing code in response to detecting the selection and drag of the graphical user interface control.

22. A computer-enabled method for displaying a graphical user interface control, the method comprising:
communicating, in response to an API listing request, an API listing indicative of a plurality of APIs;
causing a display of a plurality of API indicators;
detecting a selection of an API indicator of the plurality of API indicators, the API indicator associated with one API of the plurality of APIs;
causing a display of a plurality of user interface control indicators;
detecting a selection of a first user interface control indicator of the plurality of user interface control indicators, the first user interface control indicator associated with the graphical user interface control, wherein the graphical user interface control is compatible with the one API of the plurality of APIs associated with the API indicator;
detecting an API call, the API call using the one API of the plurality of APIs associated with the API indicator;
communicating response data in response to the API call; and
causing a display of the graphical user interface control, the graphical user interface control using at least a subset of the response data.

23. The computer-enabled method of claim 22, wherein the plurality of APIs includes a subset of supported APIs, the subset of supported APIs determined based on the availability of supported APIs.

24. The computer-enabled method of claim 22, wherein each of the plurality of API indicators are associated with one or more APIs of the plurality of APIs.

25. The computer-enabled method of claim 23, further comprising:
receiving request data as part of detecting the API call; and
causing a display of at least one of the request data and the response data.

26. The computer-enabled method of claim 25, wherein the response data is caused to be displayed based on a format selected from the group consisting of a raw format, a javascript object notation (JSON) format, and an extensible markup language (XML) format.

27. The computer-enabled method of claim 25, wherein:
the first user interface control indicator is associated with a first computing code of a first computing language; and
a second user interface control indicator of the plurality of user interface control indicators is associated with a second computing code of a second computing language.

28. The computer-enabled method of claim 25, further comprising:
detecting a selection and drag of the graphical user interface control; and
communicating at least a portion of the first computing code in response to detecting the selection and drag of the graphical user interface control.
